(19) United States
(12) Patent Application Publication
(10) Pub. No.: US 2011/0120283 A1
(43) Pub. Date: May 26, 2011

(54) Counter-Die Cylinder for a Machine for Stamping Sheet-Like Material and Method for Mounting/Removing a Cover

(76) Inventors: Ramon Serra Obiol, Barcelona (ES); Tristany Serra Ruiz, Barcelona (ES)

(21) Appl. No.: 12/997,646

(22) PCT Filed: Jun. 8, 2009
(86) PCT No.: PCT/ES2009/070211

§ 371 Date: Feb. 3, 2011

(30) Foreign Application Priority Data
Jun. 13, 2008 (ES) 200801788

(51) Int. Cl. B26D 7/26; B26D 1/40; B23P 17/00

(52) U.S. Cl. 83/347; 83/659; 29/426.2

(57) ABSTRACT

Counter-die cylinder for a machine for stamping sheet-like material comprising a cylindrical body (1), a tubular member (2) arranged around the cylindrical body, at least one cover (3) which is arranged around said tubular member (2), and fixing means for positioning/removing the at least one removable cover, comprising said fixing means a support housed inside an axial housing (14) located in the tubular member (2) associated in a fixedly manner to two ends of at least one cover, in such a way that the two ends of the cover (3) can be moved in an opening and closing direction for the removing/positioning thereof. Thus, the operation of removing the covers becomes easier and faster.

### OBJECT OF THE INVENTION

The present invention is related to a counter-die cylinder for a stamping machine that incorporates significant innovations and advantages and also a method for mounting/removing a cover in a counter-die cylinder for a stamping machine.

More specifically, the invention relates to a counter-die cylinder for a machine for stamping sheet-like material comprising a cylindrical body, a tubular member arranged around the cylindrical body, at least one cover arranged around said tubular member and fixing means for positioning/removing the at least one cover, allowing said operation to be carried out in a simple and fast manner.

### BACKGROUND OF THE INVENTION

It is well-known that a type of rotary stamping machines, for example, those used for the manufacture of boxes from corrugated cardboard sheets whose operating principle is based on passing a sheet of corrugated cardboard between two cylinders, are provided with a die-holder cylinder where the die and a counter-die cylinder are mounted and provided with covers that are usually made of plastic sheet-like material (such as, for example, Polyurethane) where the blades for cutting the corrugated cardboard are sunken.

The covers usually become worn over time through penetration of the die-blades, which may cause problems during stamping operations up to the point of preventing cutting.

A known solution to reduce this drawback involves applying a slow axial movement of the counter-die cylinder such that the worn area of said counter-die cylinder is more evenly distributed and not focused on one particular area. There are also known cover rotary systems such that this wearing is distributed more uniformly along the entire length of the counter-die cylinder.

In the known manual systems for fixing/removing a cover it is necessary to use two or more tools that cause wear on the cover gaskets, a slow rotation of the covers and involve an increased operation time for replacement of the cover.

On the other hand, it has been observed in the known semi-automatic type of fixing systems for covers the presence of an empty space between polyurethane cover and surface of counter-die cylinder due to intrinsic design of mounting mechanism. This empty space causes creation of soft points in teh polyurethane surface causing a bad cut in that area since the blades of die does not cut on a rigid base due to sheet material to be cut and polyurethane cover are deformed by contact into die.

### DESCRIPTION OF THE INVENTION

The invention herein has been developed with the aim of providing a counter-die cylinder that resolves the aforementioned drawbacks, providing also other additional advantages that will be apparent from the description detailed hereinafter.

It is therefore an object of the present invention to provide a counter-die cylinder for a machine for stamping sheet-like material comprising a cylindrical body, a tubular member arranged around the cylindrical body, at least one cover arranged around said tubular member and fixing means for positioning/removing the at least one removable cover, and is characterized by the fact that said fixing means comprises a support housed inside an axial housing located in the tubular member fixed to two ends of at least one cover, such that the two ends of the cover can be moved in an opening and closing direction for the removing/positioning thereof. Said support is provided with a buffer block joined to one end of the cover, a hooking member that can be moved perpendicularly with respect to the longitudinal axis of the cylindrical body joined to the other end of the cover, such that at least one of the two ends of the cover can be moved in an opening and closing direction with respect to the other end of the cover.

Thanks to these characteristics, an easily implemented innovative solution is obtained, allowing the covers over the tubular member to be maintained in a fixed position and at the same time enabling free rotation and axial translation with respect to the counter-die cylinder such that a considerable reduction in the replacement operation time and/or moving of the covers is provided.

In a preferred embodiment, the buffer block may consist of a portion that protrudes outwards from the support.

In accordance with another characteristic of the invention, the hooking member is attached to a shaft provided with at least a wedge member such that on rotating the shaft on the axis thereof, the hooking member moves transversely on said member contacting with at least one wedge member. In this way, through a relatively simple construction solution, the removing/positioning of a cover can be carried out efficiently.

Preferentially, the shaft is geometrically shaped at one end so it can be coupled to a rotation tool to make a fast and simple rotation of the shaft and thus the removal of the cover.

In a particularly preferred embodiment, the shaft comprises two wedge members attached to a protruding section that protrudes from the inner wall of the housing.

The fixing means is shaped such that the outer part matches the curved contour of the tubular member.

Another advantage that emerges from the fixing means described herein is the fact that when the mechanism is closed, there is no empty space on the surface in contact with the cover that could create a situation of not cutting the template to be used.

Additionally, the counter-die cylinder comprises a retention mechanism to retain the tubular member with respect to the cylindrical body, with said mechanism being formed by a cotter pin arranged axially and adjustable by elastic means, such that in a standby condition the cotter pin is hidden such that the tubular member is rotative with respect to the cylindrical body.

Said elastic means consists of at least one coil spring attached to a movable piston, whose piston is joined to the cotter pin.

According to another aspect of the invention, a method for mounting/removing a cover of a counter-die cylinder for a machine for stamping sheet-like material is provided, including a plurality of covers arranged in series joined to their respective tubular members, comprising the steps of:
Moving the hooking member in the opposite direction to the support buffer block, such that the two ends of a cover remain separated at a distance sufficient to remove one of the ends of said cover;
Disassembling the tubular member;
Moving the other tubular members with their respective covers in the direction of the space occupied by the cover to be removed by sliding;
Mounting the previously removed tubular member;
Positioning the previously removed cover over said tubular member; and
Moving the hooking member in the direction of the buffer block until the two ends of the cover are in contact with each other.

Other characteristics and advantages of the counter-die cylinder object of the present invention will become apparent from the description of a preferred, although not exclusive embodiment, which is illustrated by way of non-limiting example in the drawings appended, in which:

### BRIEF DESCRIPTION OF THE DRAWINGS

FIG. 1.—Cross-sectional view of a counter-die cylinder in accordance with the invention and detail of the fixing means in a condition of removal of the cover;

FIG. 2.—Cross-sectional view of a counter-die cylinder and detail of the fixing means in a condition of operation of the counter-die cylinder;

FIG. 3.—Perspective view of increased detail of the fixing means arranged in a counter-die cylinder of the invention;

FIG. 4.—Sequential view of a process in accordance with the present invention; and

FIG. 5.—Cross-sectional view in which the retention mechanism is shown.

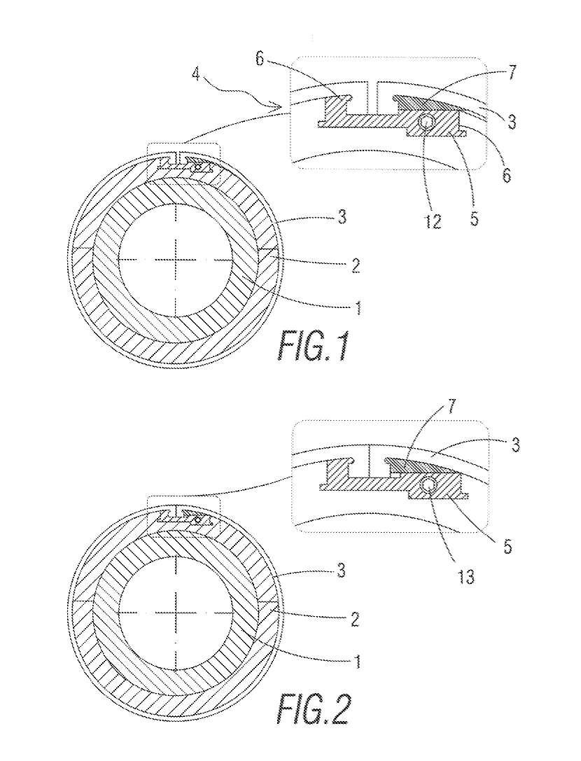

### DESCRIPTION OF A PREFERRED EMBODIMENT

As shown in an embodiment of the invention, a counter-die cylinder for a machine for stamping sheet-like material (not shown), such as for the formation of templates for corrugated cardboard boxes, comprising a cylindrical body (1) internally hollow and made from steel, a tubular member (2) formed by two halves arranged around the cylindrical body (1), a plurality of covers (3) that are wrapped around said tubular member (2) and fixing means to position/remove the covers (3) as detailed hereinafter.

With reference to the fixing means, generally referenced with (4), they comprise a support (5) housed on the inside of the axial housing located in the tubular member (2), with said support (5) provided with a buffer block (6) joined to one end of the cover (3), a hooking member (7) that can be moved perpendicularly with respect to the longitudinal axis of the cylindrical body (1) joined to the other end of the cover (3) , such that the two ends of the cover (3) can be moved in an opening and closing direction for the removal and replacement or movement thereof in the case of being worn.

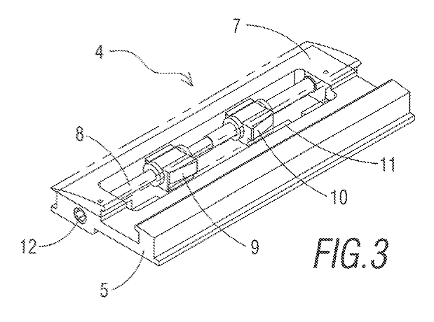

As can be seen more clearly in FIG. 3, the hooking member (7) is attached to a shaft (8) provided with a pair of wedges (9), (10) such that on rotating the shaft (8) on the axis thereof the hooking member (7) moves transversely on said wedge member. The end of the shaft (8) has a hexagonal orifice (12) for inserting a key that allows the operator to manually rotate the shaft (8) with the aim of allowing the movement of the hooking member (7). In FIG. 3 part of the hooking member (7) has been shown using broken lines to display the components that remain hidden, in particular the wedge members (9), (10).

A method for mounting/removing a cover (3) for the counter-die cylinder described hereinabove is carried out manually in the following manner:

Firstly, move the hooking member (7) in the opposite direction to the support (5) buffer block (6) of the fixing means such that the two ends of a cover remain separated at a distance sufficient to remove one of the ends of the said cover (3); manually disassemble the tubular member (2); move the other tubular members (2) with their respective covers (3) in the direction of the space occupied by the cover to be removed by sliding; reassemble the tubular member (2) previously removed; position previously removed cover (3) over said tubular member (2); and finally move the hooking member in the direction of the buffer block (6) until the two ends of the cover (3) are in contact with each other.

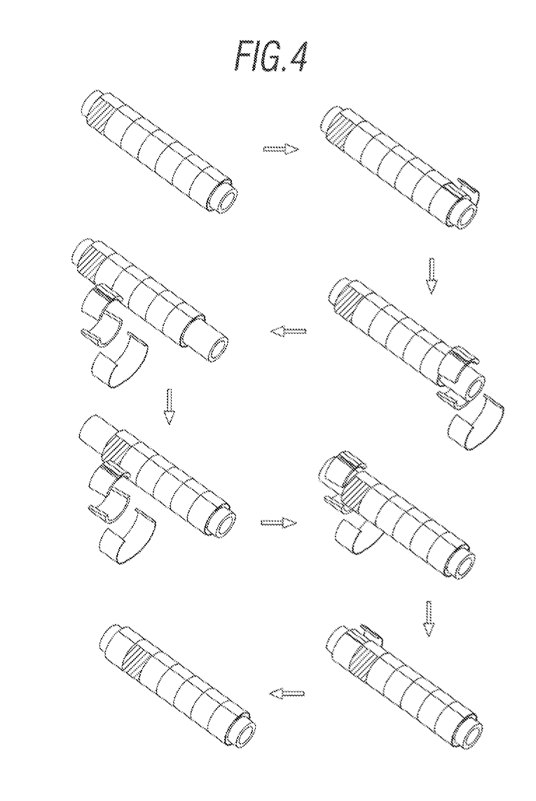

FIG. 4 shows one of the covers in striped lines in order to observe the movement of the various covers in the counter-die cylinder during the removal and mounting process thereof.

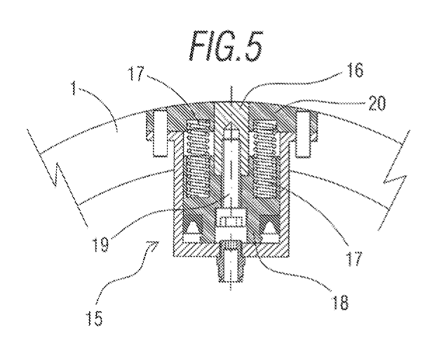

FIG. 5 shows a retention mechanism generally referenced with (15) that allows the tubular member (2) to be retained (not shown in this FIG. 5) with respect to the cylindrical body (1) such that one can rotate freely or not with respect to the other. This retention mechanism (15) is formed by a cotter pin (16) arranged axially along the counter-die cylinder , such that in a standby condition the cotter pin is maintained hidden by elastic means such that the tubular member can rotate with respect to the cylindrical body (1).

The elastic means consists of coil springs (17) attached to a movable piston (18), whose piston (18) is joined by means of a screw (19) to the cotter pin (16). For maintenance and cleaning, a detachable upper lid (20) is provided.

The details, shapes and dimensions and other accessory members as well as the materials used in the manufacture of the counter-die cylinder of the invention may be conveniently replaced by others which are technically equivalent and do not depart from the essential nature of the invention or from the scope defined by the claims appended hereinafter.

1. Counter-die cylinder for a machine for stamping sheet-like material comprising a cylindrical body (1), a tubular member (2) arranged around the cylindrical body, at least one cover (3) arranged around said tubular member and fixing means for positioning/removing said at least one cover, that said fixing means comprises a support housed inside an axial housing located in the tubular member (2) associated in a fixedly manner to two ends of at least one cover (3), such that the two ends of the cover (3) can be moved in an opening and closing direction for the removing/positioning thereof, characterised in that said support is provided with a buffer block (6) joined to one end of then cover (3), a hooking member (7) that can be moved perpendicularly with respect tot eh longitudinal axis of the cylindrical body joined to the other end of the cover (3), such that at least one of the two ends of the cover (3) can be moved in an opening and closing direction with respect to the other end of the cover, and wherein said hooking member (7) and said buffer block (6) of the fixing means are shaped such that the respective outer parts match the curved contour of the outer wall of the tubular member (2).

2. Counter-die cylinder, for a stamping machine according to claim 1, wherein the buffer block (6) comprises a portion protruding outwardly from the support.

3. Counter-die cylinder for a stamping machine according to claim 1, wherein the hooking member (7) is associated to a shaft (8) provided with at least a wedge member (9, 10) such that on rotating the shaft (8) on the axis thereof, the hooking member moves transversely on said member contacting with a wedge member.

4. Counter-die cylinder for a stamping machine according to claim 3, wherein the shaft (8) is geometrically shaped at one end so it can be coupled to a rotation tool.

5. Counter-die cylinder for a stamping machine according to claim 3, wherein the shaft (8) comprises two wedge members associated to a protruding section that protrudes from the inner wall of the hooking member (7).

6. Counter-die cylinder for a stamping machine according to claim 1, wherein the tubular member (2) is formed by two halves with a substantially semicircular section.

7. Counter-die cylinder for a stamping machine according to claim 1, wherein the tubular member (2) is detachable.

8. Counter-die cylinder for a stamping machine according to claim 1, comprising a retention mechanism (15) for retaining the tubular member with respect to the cylindrical body (1).

9. Counter-die cylinder for a stamping machine according to claim 8, wherein said retention mechanism (15) is formed of a cotter pin arranged axially adjustable by elastic means, such that in a standby condition the cotter pin (16) is hidden in such a way that the tubular member (2) can rotate with respect to the cylindrical body (1).

10. Counter-die cylinder for a stamping machine according to claim 9, the elastic means comprising at least a coil spring (17) attached to a movable piston (18), whose piston (18) is joined to the cotter pin.

11. Stamping machine of sheet-like material comprising a die-holder cylinder provided with a die and a counter-die cylinder according to claim 1.

12. Method for mounting/removing a cover on a counter-die cylinder for a stamping machine, whose counter-die cylinder is of a type according to claim 1, including a plurality of covers (3) arranged in series joined to their respective tubular members, comprising the steps of:
Moving the hooking member of the fixing means of the cover in the opposite direction to the support buffer block in such a way that the two ends of a cover remain separated at a distance sufficient to remove one of the ends of said cover;
Disassembling the tubular member;
Moving in a sliding manner the other tubular members with their respective covers in the direction of the space occupied by the cover to be removed;
Mounting the previously removed tubular member;
Positioning the previously removed cover over said tubular member; and
Moving the hooking member towards the buffer block until the two ends of the cover are in contact with each other.

13-14. (canceled)
